(19) United States
(12) Patent Application Publication
(10) Pub. No.: US 2023/0117402 A1
(43) Pub. Date: Apr. 20, 2023

(54) SYSTEMS AND METHODS OF REQUEST GROUPING

(71) Applicant: PERION NETWORK LTD, Holon (IL)

(72) Inventors: Adi SHPAK, Rehovot (IL); Anat BERNSTEIN, Givaataim (IL); Madi ORR, Tel Aviv (IL); Assaf MEIROVICH, Herzlia (IL)

(21) Appl. No.: 17/871,510

(22) Filed: Jul. 22, 2022

Related U.S. Application Data
(60) Provisional application No. 63/256,706, filed on Oct. 18, 2021.

(51) Int. Cl. G06N 5/02

(52) U.S. Cl. CPC G06N 5/022

(57) ABSTRACT

Apparatuses, systems, and methods of training and utilizing a machine learning model to categorize data requests based on contextual signals. Using a trained machine learning model, a computer system is enabled to provide relevant content to users in the absence of third-party cookies.

### CROSS REFERENCE TO RELATED APPLICATIONS

The present application claims the benefit of and priority, under 35 U.S.C. § 119(e), to U.S. Provisional Application Ser. No. 63/256,706, filed on Oct. 18, 2021, entitled “AUDIENCE CLUSTERING,” the entire disclosure of which is hereby incorporated by reference, in its entirety, for all that it teaches and for all purposes.

### FIELD OF THE DISCLOSURE

The present disclosure is generally directed to providing content in response to requests, and more particularly to a system for automatically determining relevant content to provide in response to a request.

### BACKGROUND

Conventional systems for providing relevant content to users relies on third-party cookies. The use of third-party cookies is conventionally an essential element of the marketing mix for many organizations. Cookies are the backbone of marketing campaign. Businesses and marketing strategists rely heavily on third-party cookies.

Third-party cookies are pieces of code that allow companies to track and identify users' browsing and shopping habits on their website. They are set by a third-party server (ad-tech) via a code placed on the web domain by the owner of that domain.

Third-party cookies allow advertisers to track users across the internet (cross-site) and target advertising wherever that user goes. This data allows marketers to learn more about what customers want, why they might be visiting a web page or site, and how long they stay there. Third-party cookies enable marketers to understand customer behavior to customize messaging and optimize campaigns based on specific customer segments.

User privacy, however, is a critical issue as it pertains to digital advertising. Ad platforms and browsers alike are taking steps to improve transparency and privacy. Much of the digital marketing discussion today focuses on data privacy, specifically managing what consumers consent to share and for what purposes.

Marketers are in a constant battle to keep up with the ever-evolving digital landscape. With GDPR and CCPA legislation and the new Browsers restrictions on third-party cookies marketers challenge is how to track their audience and thus provide personalized content without cookies.

Third-party cookies are disappearing: Leading browsers have made public announcements and technical deployments to reduce the digital advertising accessibility of third-party cookies for data collection, storage, and sharing. As a result, there has been growing momentum to find an alternative via cookie-less IDs, with the intent to create a replacement that helps ensure continuity across the ecosystem. Browsers such as Safari and Firefox eliminated cookies completely and Chrome announced it will eliminate cookies.

Advertisers in the ad tech industry relay heavily on identifying users and target them based on third-party cookies. Without cookies advertisers will not be able to target users based on segments or retarget them. Companies are looking for alternatives to cookies, such as Authentication-based ids (e.g., IDL by LiveRamp, ID5_id by ID5, TTD unified id 2.0 by The Trade Desk). These Ids are based on user email as the new user identifier. However, the scale for these ids is unknown and will be limited because it requires the user to insert their email on publisher sites when reading content on web.

Contextual Targeting will become more dominant as targeting tactic as an alternative to cookies. GDPR and CCPA regulations User Privacy become increasingly important to advertisers.

### SUMMARY

In an embodiment disclosed herein, a device may be configured to receive a request from one or more user devices and, in response to the request, associate the request with one or more groups. Based on the associated group of the request, certain content may be provided in response to the request. Systems and methods as described herein offer a number of advantages over conventional approaches to providing relevant content to users. For example, the systems and methods described herein are capable of presenting relevant content and achieving a high click-through-rate without relying on third-party cookies. Additional features and advantages are described herein and will be apparent from the following description and the figures.

### BRIEF DESCRIPTION OF THE DRAWINGS

The present disclosure is described in conjunction with the appended figures, which are not necessarily drawn to scale:

FIG. 1 is an illustration of a computing environment in accordance with one or more embodiments of the present disclosure;

FIGS. 2A and 2B are graphs of requests in accordance with one or more embodiments of the present disclosure;

FIGS. 3-5 are flowcharts of methods in accordance with one or more embodiments of the present disclosure;

FIGS. 6A and 6B are charts of evaluation metrics in accordance with one or more embodiments of the present disclosure;

FIGS. 7A and 7B are illustrations of aggregations of requests into groups in accordance with one or more embodiments of the present disclosure; and

FIG. 8 is a block diagram of a service for providing ad content in accordance with one or more embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a PCB, or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The terms “determine,” “calculate,” and “compute,” and variations thereof, as used herein, are used interchangeably, and include any appropriate type of methodology, process, operation, or technique.

Various aspects of the present disclosure will be described herein with reference to drawings that may be schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

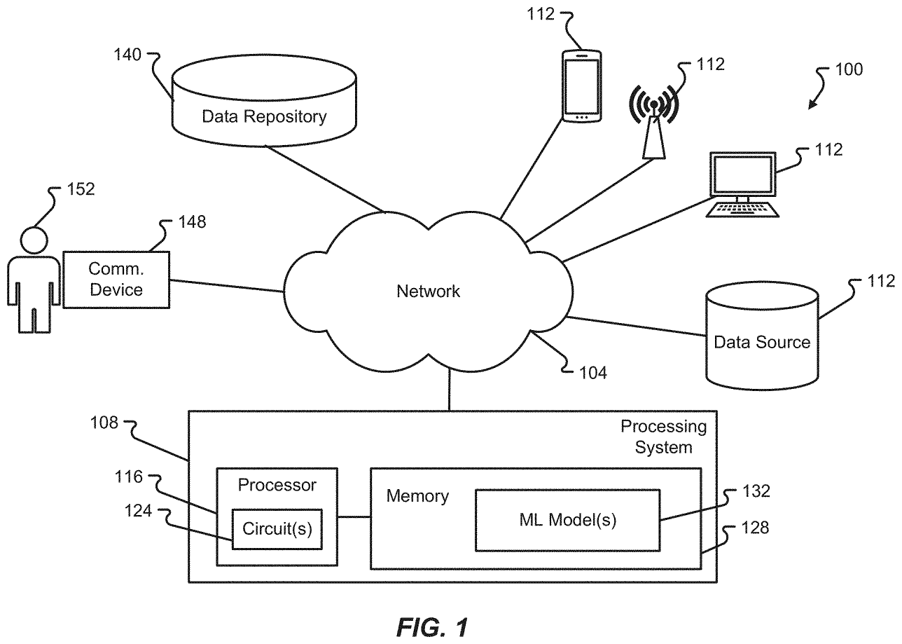

Referring now to FIGS. 1-6B, various systems and methods for training and utilizing an artificial intelligence (“AI”) or machine learning (“ML”) model to categorize each request of a plurality of received requests into one of a plurality of groups will be described. While various embodiments will be described in connection with utilizing AI and similar techniques, it should be appreciated that embodiments of the present disclosure are not limited to the use of AI or other artificial intelligence/machine learning techniques, which may or may not include the use of one or more neural networks. As used herein, AI may refer to any of artificial intelligence, machine learning, neural network, or a combination thereof. AI as described herein may be implemented in hardware or software. For example, AI may comprise one or more of CPUs, GPUs, DPUs, FPGAs, ASICs, etc., which may perform the AI functions described herein. The methods and systems described or claimed herein can be performed with traditional executable instruction sets that are finite and operate on a fixed set of inputs to provide one or more defined outputs. Alternatively, or additionally, methods and systems described herein can be performed using AI, ML, neural networks, or the like. A system or components of a system as described herein are contemplated to include finite instruction sets and/or AI-based models/neural networks to perform some or all of the processes or steps described herein.

In some embodiments, AI is utilized to sort incoming bid requests to divide the bid requests into a plurality of groups. The requests as described herein may be non-cookie based and GDPR and/or CCPA compliant. In some embodiments, an algorithm may be used to divide a training set of requests into a number, e.g., 30, of groups based on a plurality of factors. The training set and the group information may be used to train a model trained to categorize a request that is newly received, or part of a testing set into one of the number of groups. In some embodiments, the model may be evaluated by comparing average click-through-rates and/or other key performance indicators (“KPIs”) of requests within each group with an overall average click-through rate and/or other KPIs. In some embodiments, as described herein, factors which may be used to categorize requests may be, for example, contextual information about content related to a request, a type of device making the request, an operating system of the device making the request, a date and/or time of the request, a geographical location of the device making the request, weather information for the location of the device, a price of the device, and/or other information.

Referring to FIG. 1, an illustrative computing environment 100 will be described in accordance with at least some embodiments of the present disclosure. A computing environment 100 may include a communication network 104, which is configured to facilitate machine-to-machine communications. In some embodiments, the communication network 104 may enable communications between several types of computer systems, which may also be referred to herein as data sources 112. One or more of the data sources 112 may be provided as part of a common network infrastructure, meaning that the data sources 112 may be owned and/or operated by a common entity. In such a situation, the entity that owns and/or operates the network including the data sources 112 may be interested in obtaining data packets from the various data sources 112.

Non-limiting examples of data sources 112 may include communication endpoints (e.g., user devices, Personal Computers (PCs), computing devices, communication devices, Point of Service (PoS) devices, laptops, telephones, smartphones, tablets, wearables, etc.), and network devices (e.g., routers, switches, servers, network access points, etc.). A data source 112 may alternatively or additionally include a data storage area that is used to store bid requests generated by various other machines connected to the communication network 104. The data storage area may correspond to a location or type of device that is used to temporarily store requests until a processing system 108 is ready to retrieve and process the requests.

In some embodiments, a processing system 108 is provided to receive requests from one or more data sources 112. The processing system 108 may in some embodiments be executed on one or more servers that are also connected to the communication network 104. The processing system 108 may be configured to execute a model trained to associate an incoming request with one of a plurality of groups. It should be appreciated that the processing system 108 and components thereof (e.g., processor 116, circuit(s) 124, and/or memory 128) may be deployed in any number of computing architectures. For instance, the processing system 108 may be deployed as a switch, a NIC, a server, a collection of servers, a collection of blades in a single server, on bare metal, on the same premises as the data sources 112, in a cloud architecture (enterprise cloud or public cloud), and/or via one or more virtual machines.

Non-limiting examples of a communication network 104 include an Internet Protocol (IP) network, an Ethernet network, an InfiniBand (TB) network, a FibreChannel network, the Internet, a cellular communication network, a wireless communication network, combinations thereof (E.g., Fibre Channel over Ethernet), variants thereof, and the like.

The processing system 108 is shown to include a processor 116 and memory 128. While the processing system 108 is only shown to include one processor 116 and one memory 128, it should be appreciated that the processing system 108 may include one or many processing devices and/or one or many memory devices. The processor 116 may be configured to execute instructions stored in memory 128 which may involve utilizing one or more ML models 132 stored in memory 128. As some non-limiting examples, the memory 128 may correspond to any appropriate type of memory device or collection of memory devices configured to store instructions and/or instructions. Non-limiting examples of suitable memory devices that may be used for memory 128 include Flash memory, Random Access Memory (RAM), Read Only Memory (ROM), variants thereof, combinations thereof, or the like. In some embodiments, the memory 128 and processor 116 may be integrated into a common device (e.g., a microprocessor may include integrated memory).

In some embodiments, the processing system 108 may have the processor 116 and memory 128 configured as a GPU. The processor 116 may include one or more circuits 124 that are configured to execute an AI system using, for example, one or more ML models 132 stored in memory 128. Alternatively, or additionally, the processor 116 and memory 128 may be configured as a CPU. A GPU configuration may enable parallel operations on multiple sets of data, which may facilitate the real-time processing of one or more requests from one or more data sources 112. If configured as a GPU, the circuits 124 may be designed with thousands of processor cores running simultaneously, where each core is focused on making efficient calculations.

In some embodiments, the circuits 124 of the processor 116 may be configured to execute a model in a highly efficient manner, thereby enabling real-time processing of incoming requests to provide relevant content to users. The processing system 108 may also be configured to evaluate the performance of the model and/or to update the model with a newly trained model over time.

As noted above, the data source(s) 112, data repository 140, and/or the processing system 108 may include storage devices and/or processing circuitry for conducting computing tasks, for example, tasks associated with controlling the flow of data internally and/or over the communication network 104. Such processing circuitry may comprise software, hardware, or a combination thereof. For example, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally, or alternatively, the processing circuitry incorporated in a data source 112 and/or processing system 108 may comprise hardware, such as an application specific integrated circuit (ASIC). Other non-limiting examples of the processing circuitry include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, or the like. Some or all of the processing circuitries may be provided on a Printed Circuit Board (PCB) or collection of PCBs. It should be appreciated that any appropriate type of electrical component or collection of electrical components may be suitable for inclusion in the processing circuitry.

In addition, although not explicitly shown, it should be appreciated that the data source(s) 112, data repository 140, and/or the processing system 108 may include one or more communication interfaces for facilitating wired and/or wireless communication between one another and other unillustrated elements of the environment 100.

Embodiments of the present disclosure contemplate operating a processing system 104 using one or more ML models 132 stored in memory 128. The ML model(s) 132 may be used by the processor 116 of the processing system to execute an AI system as described herein.

To be enabled to provide free content to users, websites have a need to present advertising content to visitors to the site. To be successful, advertising content should be relevant to each visitor. Relevancy may be estimated based on a measurement of a performance indicator such as click-through-rates, i.e., how often a user, upon viewing content, clicks the content to visit another site, or a measurement of an amount of time the user viewed the content, interacted with the content, or other measurable factors.

To achieve this needed function, a site may share information about users visiting the site to processing system 108 as illustrated in FIG. 1. It should be appreciated that while embodiments described herein relate to the presenting of advertising content, the same or similar systems and methods may be used to provide any type of content to users.

When a user visits a site, the user requests data from the site. This request is associated with data such as a time and date of the request, a location of the requesting device, and a type of device being used.

As users of computing devices surf the web and visit websites, requests are generated with each new site accessed by a device. Requests contain data which is shared with the accessed site even without the use of cookies. Such data may include information such as a location and a type of device being used.

The request is also associated with data which can be determined based on the data with the request. For example, information such as local weather of the location of the requesting device, e.g., temperature, season, precipitation, etc., demographic information of the location of the requesting device, e.g., average income level, education level, etc., information about the device itself, e.g., type of device (desktop, smartphone, tablet, etc.), operating system, price of the device, etc., and information about the webpage, such as a topic or category of content in the page (e.g., finance, travel, sports). The topic or category of content may be a general category, such as finance, travel, or sports, or a more specific category, such as insurance, car rental, or cycling.

Each request may comprise a plurality of data points. Such data points may include, for example, contextual signals, external signals, and/or user signals.

In some embodiments, requests may be received in the form of data packets comprising header information and a payload. Such a data packet may comprise a plurality of fields and each field may be associated with a particular data point. Data points may be numbers, text, or some combination thereof.

Contextual signal data may include information associated with content displayed in the requested webpage, i.e., a category describing the content of the page that the user is requesting. Such a category may be, for example, a broad topic such as finance, travel, or sports, and/or may be a more particular topic, such as insurance, car rental information, or cycling.

User signal data may include information such as a date and time of the request, a type of device making the request, an operating system of the device making the request, and location information such as city, state, and/or country of the device making the request.

External signal data may include data which can be determined based on the contextual signal data and/or the user signal data. For example, based on the type of device, a price of the device may be determined. Based on the location of the device, information about the location, such as whether the location is urban or rural, an average income of the area, current weather at the location, or other information may be determined.

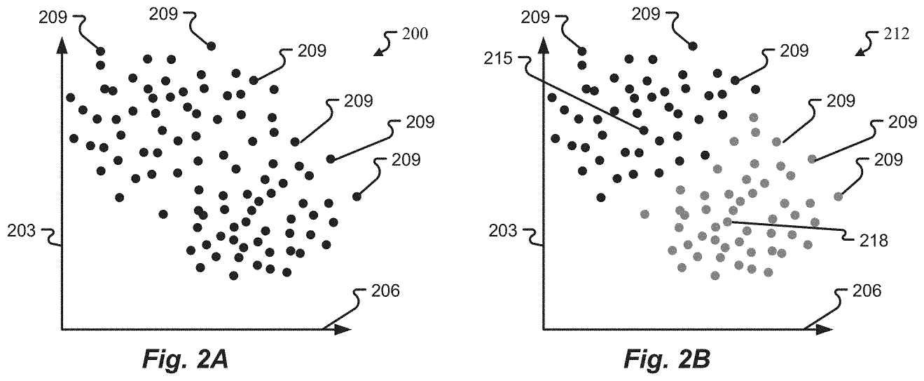

Data associated with the requests may be used to distinguish and characterize the requests. A simplified illustration is shown in FIGS. 2A and 2B. In the charts 200, 212 of FIGS. 2A and 2B, requests 209 are associated with two groups. As should be appreciated, a single request is associated with one group, though several requests arriving from the same physical user may each be classified to a different group according to the different user, contextual, and/or external signals of each request as described herein.

In the case of data points comprising numerical values, the requests 209 may be plotted in an x-y, axis. It should be appreciated that in practice requests may be multi-dimensional with any number of datapoints being used to characterize the requests. Furthermore, as datapoints may be text or a combination of numbers and text, the points may not necessarily be plottable. It should again be appreciated the chart is shown for illustration purposes only.

The chart 212 of FIG. 2B is shown for illustration purposes only, but as can be seen, requests 209, represented by points on the chart 212, may be divided into groups centered around centroids 215, 218, with the lighter points being grouped around centroid 218 and the darker points around centroid 215. While only two groups are shown in FIG. 2, it should be appreciated that any number of groups may be used. In embodiments described herein, thirty groups are used, though it should be appreciated a greater or lesser number of groups may be used. Also, the term smart group may be used to describe a group of requests sorted based on data associated with the requests.

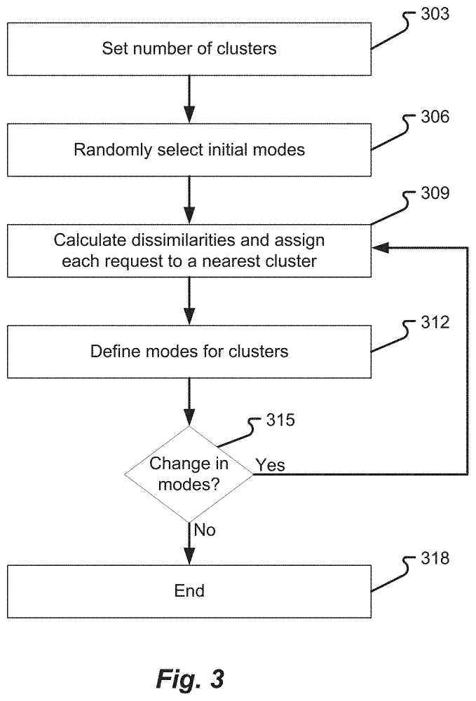

As used herein, dimensions of the points may refer to the data associated with each request. For example, location data, context data, etc. To create the groups of requests a method, as illustrated in FIG. 3, of sorting requests into groups may be performed.

At 303, a number of clusters, or groups, may be set. The number of clusters may be set at any number greater than one. The number of clusters may be set based on the type of implementation and may be in a direct relation with the number of requests to be grouped. For example, the number of clusters may be set at a higher number for testing data comprising a higher number of requests, such that each group may contain a plurality of requests.

At 306, an initial mode, or centroid, for each cluster may be selected from among the requests. For example, for each cluster, a different point may be selected at random. For thirty groups, thirty requests may be chosen at random. Because each request may comprise a plurality of datapoints, each datapoint of a request chosen as a centroid may be used to compare the request with other requests.

At 309, dissimilarities between each request may be calculated and each request may be assigned to a nearest cluster. Calculating dissimilarities may be performed by comparing each datapoint of each request to each datapoint of each other request. Requests with more datapoints in common may be grouped together. The requests may be clustered based on closest points. It should be appreciated in some embodiments each group may have a different number of requests.

In some embodiments, a k-modes algorithm may be utilized to measure a binary distance metric for each dimension of a request. For example, the following formula may be used:

$$d ( X , y ) = {\sum }_{j = 1}^{m} δ ( {x}_{j} , {y}_{j} ) , where δ ( {x}_{j} , {y}_{j} ) = \{ \begin{matrix}0 ( {x}_{j} = {y}_{j} ) \\ 1 ( {x}_{j} \neq {y}_{j} )\end{matrix}$$

At 312, a new mode may be defined for each cluster. After grouping the requests into preliminary groups based around randomly selected initial modes, it may be evident that the randomly selected initial modes are not centroids of the groups. As such, the most average request from within each cluster may be selected as a new mode for the cluster. selecting the most average request from within each cluster may comprise averaging values of datapoints of each request within a group or calculating a mode of each datapoint.

In some embodiments, the dimensions being evaluated may not be numerical. As such, a mode analysis may be implemented. Instead of calculating an average value, the algorithm may comprise counting factors which are in common between requests. In some embodiments, a binary distance metric may be used for each dimension, where 0 represents the points being the same, and 1 represents the points not being the same.

The most frequently occurring values within a cluster may be determined and the request with the greatest number of datapoints matching or close to the most frequently occurring values may be determined and selected to be a new mode for the cluster.

While the above description relates to using modes, it should be appreciated that in different embodiments, different algorithms may be used to sort requests into groups. For example, in some embodiments, it may be possible to use a k-means algorithm in combination with or instead of a k-modes algorithm. A k-means algorithm may be, for example,

to cluster request data into clusters based on closest points,
for every i, set

$${c}^{( i )} := arg {min}_{j} {‖ {x}^{( i )} - {μ}_{j} ‖}^{2} ,$$

and
to calculate the mean of each cluster,
for each j,

$${μ}_{j} := \frac{{\sum }_{i = 1}^{m} 1 \{ {c}^{( i )} = j \} {x}^{( i )}}{{\sum }_{i = 1}^{m} 1 \{ {c}^{( i )} = j \}} .$$

At 315, a determination may be made as to whether the newly defined mode differs, for any group, from the previous mode. If a change in the mode of any group has occurred, the method may return to 309 in which the dissimilarities may be again calculated.

This process of selecting a mode of each group, regrouping the requests around the selected modes, and determining the new mode of each group may be repeated until convergence, or until no change in the mode has occurred after regrouping. If no change has occurred, the method may end at 318 in which the requests have been successfully grouped.

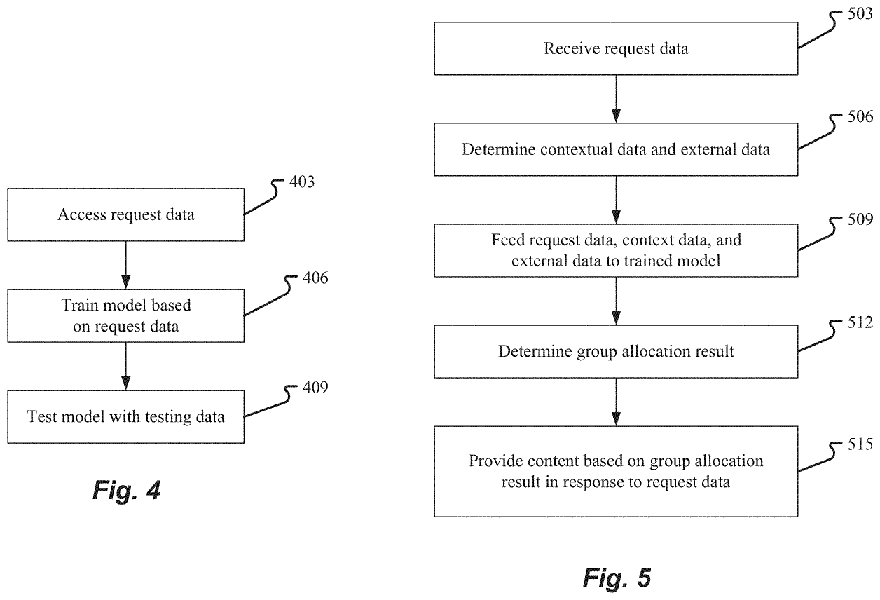

As described herein, a model may be trained and used to divide an audience into groups. The training may be performed via a method such as illustrated in FIG. 4. At 403, request data for training may be accessed. Training request data may be real bid requests received in real time and compiled into a group or may be historical request data received from a network location. Request data may comprise, as described herein, contextual data, user data, and external data relating to each request. For example, a date, time, and location of the device making the request, a type of device making the request, and the type of content in the webpage being requested may be included in each request. Each of such datapoints may be used to categorize each request into a group to train a model.

At 406, the requests may be divided into a plurality of groups based on differences and similarities in the datapoints/signals. In some embodiments, thirty groups may be used. The process of dividing requests into groups may be as described above in relation to FIG. 3. For example, one request may be selected at random as an initial mode of each group, the requests may be grouped based on the initial modes, new modes may be determined, and the requests may be regrouped around the new modes. The process may continue until convergence.

During step 406, training data may be obtained. Training data may comprise the request data. The process of training the model is performed done from scratch, taking newly received request data, defining the required modes, and generating a representation of the model to enable the model to classify future requests which the model has not yet encountered.

An AI or ML model may be trained with the request data and data associating each request with a group. The model may be, for example, a neural network such as a convolutional neural network or other form of AI engine.

At 409, the trained model may be tested using additional request data which may be referred to as testing data. Testing data may comprise request data which is entered into the model and known group data which may be used to verify an output group association generated with the model.

The model may be used to estimate or predict a group for each request in the test set. For example, an input to the model may be a request comprising contextual signals, user signals, and external signals, and an output of the model may be a number identifying a group.

As illustrated in FIG. 5, a trained model may be used to categorize incoming requests in real time. At 503, a new request may be received. The new request may comprise, as described herein, contextual signals, user signals, and external signals. The request may be received from a server which may have received the request from a user device requesting a website. The server may seek information such as content to provide to the user device as advertisements or other forms of content.

At 506, the request may be analyzed and all related data, such as contextual data, user data, and external data may be gathered. This preprocessing step may comprise, for example, converting datapoints to be used as an input of the model into a format which may more easily be processed by the model.

In some embodiments, preprocessing may comprise determining external data associated with contextual or user data associated with the request. For example, the method may comprise determining information such as weather associated with a location of the request, a price of the device being used to make the request, or other external information.

At 509, the data comprising the request may be input into the trained model and at 512, an output of the model may be received. Based on the output, an identity of a group for the request may be determined. The output of the model, as described herein may comprise a number identifying a group to which the request belongs according to the model.

At 515, based on the identity of the group, content may be provided in response to the request. For example, if the request was sent to a computer system hosting the model by a server or other computer system, the computer system hosting the model may share results with the server or other computer system.

The content provided in response to the request may be an identity of a group or may be content such as an advertisement or other visual content. To ensure the model is preforming in a satisfactory manner, a number of evaluations may be made. Moreover, the model may be continually or periodically updated.

In some embodiments, each group may be analyzed to survey how each group interacts with or reacts to content provided in response to each request based on the grouping assignment. For example, a comparison may be made comparing an average KPI of each group, such as click-through-rate, with an overall average of the KPI for all the requests as a whole. In this way, it may be verified that each group has a different click through rate (CTR) from the total average and is statistically significant for observations.

If a group's KPI is significantly different from the overall average KPI, it can be determined the model's predictions are effective enough for distinguishing high vs. low performing groups for a campaign.

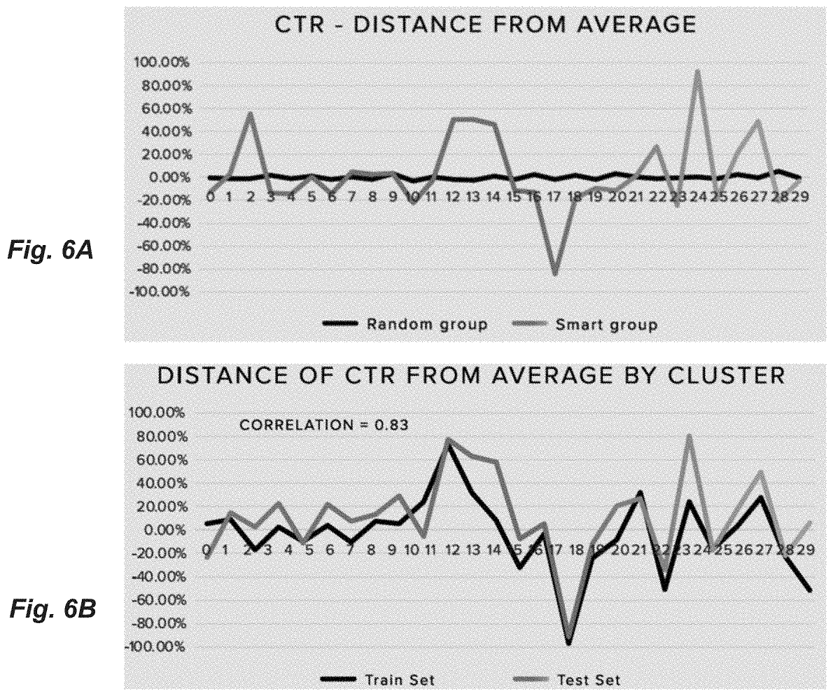

To prove the efficacy of the model and the process of dividing requests into groups, an evaluation may be performed by comparing the groups as assigned by the model to groups randomly assigned. As illustrated in FIG. 6A, requests in randomly assigned groups may be seen to have an average click-through-rate close to an average click-through-rate for the overall average request. On the other hand, by assigned to groups, or smart groups, using a method as described herein, may be seen to create certain groups which outperform or underperform the overall overage request based on click-through-rate or another KPI.

As illustrated in FIG. 6B, an evaluation may be performed to compare a training set of requests used to train a model with a test set of requests assigned to groups by the trained model.

As used herein performance KPI may be a distance from an overall average KPI. An average performance KPI may be determined for requests in each group of training requests and testing sets. If the model is performing adequately, a correlation may be seen between the performance of training set groups and test set groups as illustrated in FIG. 6B. Using such a process, the performance of the model may be continually or periodically evaluated.

Using a method as described herein, requests may be automatically assigned to high-performing and/or low-performing groups based on one or more KPIs. In some embodiments, a single model may be created which may be enabled to handle requests for a plurality of web sites based on different factors. For example, a request for a website offering sports-related content may be grouped using a number of signals including a signal representing the type of content hosted by the website.

Using a model as described herein, a service may be rendered to administrators and developers of websites and applications. When a user of a user device, such as a computer or smartphone, attempts to access a webpage, such as via a URL, a bid request may be created. As described herein a bid request may comprise information relating to both the device making the request to access the webpage—such as device hardware information, location information, and time and date information—as well as the webpage to be accessed—such as a description of content of the webpage.

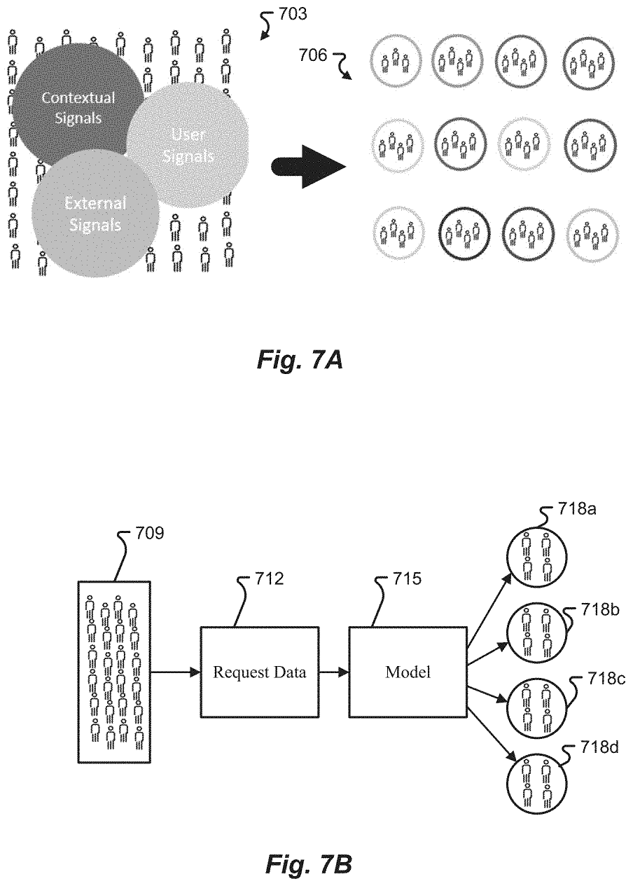

As illustrated in FIG. 7A, users attempting to load a webpage may be associated with requests 706. Each request 706 may comprise or be associated with information such as contextual signals, user signals, and/or external signals. The requests 706 may be categorized into a plurality of groups 706 as described herein.

Using an algorithm as described herein, requests may be divided into a number of different smart groups based on similarities and differences between signals associated with each request. As described herein, a request handling campaign may be established by training a model 715 to output group assignments 718a-d based on an input of request data 712. Request data 712 may be created based on requests 709 to one or more websites.

Based on request data 712, the model 715 may be enabled to output a group assignment 718a-d such that it can be expected that each request within a particular group 718a-d can be estimated to respond similarly to content such as advertisements. Meaning, for a specific campaign the groups can be sorted per high performing groups and low smart groups, where requests in a high performing group may be expected to be more likely to click-through or interact with presented content.

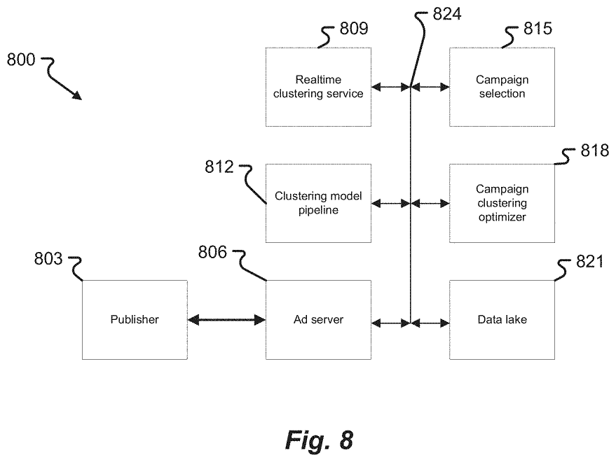

Such a model may be useful to internet content publishers using a system 800 for providing relevant advertising content to website viewers such as illustrated in FIG. 8.

A publisher 803 of a website may host one or more websites accessible to web browsers. As users seek to access a website hosted by the publisher 803, request may be generated. In order to provide relevant advertising content to the users, the publisher 803 may send requests to an ad server 806.

For example, when a new request for content is received by the publisher 803 by, for example, a user of a user device seeking to load a webpage hosted by the publisher 803, the publisher 803 may transmit request data relating to the request to the ad server 806.

The request data sent by the publisher 803 to the ad server 806 may include user data, external data, and contextual data relating to the request. For example, the publisher 803 may send an indication of a date and time of the request, information about the type of device making the request, as well as information about the content in the website being requested. The information about the content in the website being requested may include, for example, a topic or subtopic describing the content, such as travel, sports, finance, etc.

In response to the request data sent by the publisher 803 to the ad server 806, the ad server 806 may transmit ad content to the publisher 803 to serve to the requesting user device. As described herein, the ad content may be based on a grouping assigned to the request based on processing the request data—including the user data, context data, and/or external data—by a trained model.

To perform the grouping of the request data and to determine the ad content to provide in response to the request, the ad server 806 may leverage one or more systems such as a real-time clustering service 809, a clustering model pipeline 812, a campaign selection system 815, a campaign clustering optimizer 818, and a data lake 821, each of which may be connected to the ad server 806 via a network 824. The ad server 806 may be used to log cluster data into a data lake 821.

The real-time clustering service 809 may be configured to execute a trained model such that an input data request to the real-time clustering service 809 may cause the real-time clustering service 809 to output a grouping in response to the input data request as described herein.

The clustering model pipeline 812 may be used to train a version of the model to be used for grouping requests. Through the use of the clustering model pipeline 812, the training of the model may be implemented in parallel or offline without affecting the performance of the real-time clustering service 809. The clustering model pipeline 812 may output a model which may be loaded into memory of the real-time clustering service 809. In this way, the clustering model pipeline 812 may be used to transmit new model updates to the real-time clustering service 809. Updates to the model may, for example, be sent to the real-time clustering service 809 quarterly or daily.

The campaign clustering optimizer 818 may be used to implement or adjust campaign tactics. For example, campaign tactics may automatically be adjusted according to best performing clusters. In this way, based on actual performance of grouped requests, the content provided in response to the requests may be adjusted to maintain high performance according to click-through-rate or other KPIs.

The campaign selection system 815, which may be referred to as a campaign management system or CMS, may be used to handle campaign tactic adjustments via the campaign clustering optimizer 818. The campaign selection system 815 may further be used by one or more administrators or other users to make adjustments to campaign configuration settings or other settings.

The data lake 821 may be used to store data, such as in the form of tables and to log requests, request data, cluster data, or other data. The campaign clustering optimizer 818 may generate a delivery plan and adjust campaign targeting accordingly, based on data which resides in the data lake 821. The data lake 821 may be used hold and aggregate data.

While described herein as being performed by a processor of a processing system 108, it should be appreciated the systems and methods described herein may be performed by a hardware device implemented in silicon or hardware—as opposed to software.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

It should be appreciated that inventive concepts cover any embodiment in combination with any one or more other embodiment, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment.

Example embodiments may be configured according to the following:

(1) A method comprising: receiving data associated with a plurality of requests; aggregating the received data into a plurality of clusters; and training a model, based on the plurality of clusters, to associate a request with one of the plurality of clusters.

(2) The method of (1), further comprising: receiving a new request; processing the new request with the model; and determining content to provide in response to the new request based on an output of the model.

(3) The method of (1) or (2), wherein aggregating the received data comprises analyzing data associated with the request, the data associated with the request comprising one or more contextual datapoints, one or more user signals, and/or one or more external signals.

(4) The method of any of (1)-(3), wherein the data associated with the request comprises one or more of a contextual category of content associated with the request, a type of device associated with the request, an operating system associated with the request, a date associated with the request, a time associated with the request, a location associated with the request, weather associated with the request, and a price of a device associated with the request.

(5) The method of any of (1)-(4), further comprising evaluating the model by comparing an average of one or more performance indicators for each cluster with an average of the one or more performance indicators for the received data as a whole.

(6) The method of any of (1)-(5), wherein the key performance indicator is a click-through-rate for content presented in response to each request.

(7) The method of any of (1)-(6), further comprising evaluating the model by comparing an average of one or more performance indicators for each cluster with an average of the one or more performance indicators for new requests associated with each cluster.

(8) The method of any of (1)-(7), wherein aggregating the received data comprises sorting the received data using one or more of a K-means algorithm and a K-modes algorithm.

(9) A computer system comprising: a processor; and memory including instructions stored thereon, the instructions, when executed by the processor, causing the processor to: receive data associated with a plurality of requests; aggregate the received data into a plurality of clusters; and train a model, based on the plurality of clusters, to associate a request with one of the plurality of clusters.

(10) The computer system of (9), the instructions further causing the processor to: receive a new request; process the new request with the model; and determine content to provide in response to the new request based on an output of the model.

(11) The computer system of (9) or (10), wherein aggregating the received data comprises analyzing data associated with the request, the data associated with the request comprising one or more contextual datapoints, one or more user signals, and/or one or more external signals.

(12) The computer system of any of (9)-(11), wherein the data associated with the request comprises one or more of a contextual category of content associated with the request, a type of device associated with the request, an operating system associated with the request, a date associated with the request, a time associated with the request, a location associated with the request, weather associated with the request, and a price of a device associated with the request.

(13) The computer system of any of (9)-(12), the instructions further causing the processor to evaluate the model by comparing an average of one or more performance indicators for each cluster with an average of the one or more performance indicators for the received data as a whole.

(14) The computer system of any of (9)-(13), wherein the key performance indicator is a click-through-rate for content presented in response to each request.

(15) The computer system of any of (9)-(14), the instructions further causing the processor to evaluate the model by comparing an average of one or more performance indicators for each cluster with an average of the one or more performance indicators for new requests associated with each cluster.

(16) The computer system of any of (9)-(15), wherein aggregating the received data comprises sorting the received data using one or more of a K-means algorithm and a K-modes algorithm.

(17) A non-transitory computer-readable storage medium in a computer system including instructions which, when executed, cause at least one processor in the computer system to: receive data associated with a plurality of requests; aggregate the received data into a plurality of clusters; and train a model, based on the plurality of clusters, to associate a request with one of the plurality of clusters.

(18) The non-transitory computer-readable storage medium of (17), wherein the instructions further cause the at least one processor to: receive a new request; process the new request with the model; and determine content to provide in response to the new request based on an output of the model.

(19) The non-transitory computer-readable storage medium of (17) or (18), wherein aggregating the received data comprises analyzing data associated with the request, the data associated with the request comprising one or more contextual datapoints, one or more user signals, and/or one or more external signals.

(20) The computer system of any of (17)-(19), wherein the data associated with the request comprises one or more of a contextual category of content associated with the request, a type of device associated with the request, an operating system associated with the request, a date associated with the request, a time associated with the request, a location associated with the request, weather associated with the request, and a price of a device associated with the request.

(21) The computer system of any of (17)-(20), the instructions further causing the processor to evaluate the model by comparing an average of one or more performance indicators for each cluster with an average of the one or more performance indicators for the received data as a whole.

(22) The computer system of any of (17)-(21), wherein the key performance indicator is a click-through-rate for content presented in response to each request.

(23) The computer system of any of (17)-(22), the instructions further causing the processor to evaluate the model by comparing an average of one or more performance indicators for each cluster with an average of the one or more performance indicators for new requests associated with each cluster.

(24) The computer system of any of (17)-(23), wherein aggregating the received data comprises sorting the received data using one or more of a K-means algorithm and a K-modes algorithm.

1. A method comprising:
receiving data associated with a plurality of requests;
aggregating the received data into a plurality of clusters;
training a model based on the plurality of clusters;
receiving a request for content;
using the model to associate the request for the content with a first cluster of the plurality of clusters; and
based on the association of the request for the content to the first cluster of the plurality of clusters, providing content in response to the request for the content.

2. The method of claim 1, wherein the data associated with the plurality of requests comprises a summary of content from a respective webpage and data relating to a respective user device associated with each request.

3. The method of claim 1, further comprising:
receiving a new request;
using the model to associate the new request with a second cluster of the plurality of clusters; and
based on the association of the new request to the second cluster of the plurality of clusters, providing new content in response to the new request.

4. The method of claim 1, wherein aggregating the received data comprises analyzing data associated with each request, the data associated with each request comprising one or more contextual datapoints, one or more user signals, and/or one or more external signals.

5. The method of claim 4, wherein the data associated with each request comprises one or more of a contextual category of content associated with the request, a type of device associated with the request, an operating system associated with the request, a date associated with the request, a time associated with the request, a location associated with the request, weather associated with the request, and a price of a device associated with the request.

6. The method of claim 1, further comprising evaluating the model by comparing an average of one or more performance indicators for each cluster with an average of the one or more performance indicators for the received data as a whole.

7. The method of claim 6, wherein the key performance indicator is a click-through-rate for content presented in response to each request of the plurality of requests.

8. The method of claim 1, further comprising evaluating the model by comparing an average of one or more performance indicators for each cluster with an average of the one or more performance indicators for new requests associated with each cluster.

9. The method of claim 1, wherein aggregating the received data comprises sorting the received data using one or more of a K-means algorithm and a K-modes algorithm.

10. A computer system comprising:
a processor; and
memory including instructions stored thereon, the instructions, when executed by the processor, causing the processor to:
receive data associated with a plurality of requests;
aggregate the received data into a plurality of clusters;
train a model based on the plurality of clusters;
receive a request for content;
use the model to associate the request for the content with a first cluster of the plurality of clusters; and
based on the association of the request for the content to the first cluster of the plurality of clusters, provide content in response to the request for the content.

11. The computer system of claim 10, the instructions further causing the processor to:
receive a new request;
use the model to associate the new request with a second cluster of the plurality of clusters; and
based on the association of the new request to the second cluster of the plurality of clusters, provide new content in response to the new request.

12. The computer system of claim 10, wherein aggregating the received data comprises analyzing data associated with each request, the data associated with the request comprising one or more contextual datapoints, one or more user signals, and/or one or more external signals.

13. The computer system of claim 12, wherein the data associated with each request comprises one or more of a contextual category of content associated with the request, a type of device associated with the request, an operating system associated with the request, a date associated with the request, a time associated with the request, a location associated with the request, weather associated with the request, and a price of a device associated with the request.

14-17. (canceled)

18. A non-transitory computer-readable storage medium in a computer system including instructions which, when executed, cause at least one processor in the computer system to:
receive data associated with a plurality of requests;
aggregate the received data into a plurality of clusters;
train a model based on the plurality of clusters;
receive a request for content;
use the model to associate the request for the content with a first cluster of the plurality of clusters; and
based on the association of the new request to the second cluster of the plurality of clusters, provide new content in response to the new request.

19-20. (canceled)

21. The method of claim 1, wherein a first request and a second request are associated with different clusters as a result of a difference between the first request and the second request in one or more of date, time, location, and weather.

22. The method of claim 1, wherein a first request and a second request are associated with different clusters as a result of a difference between a type of device used to make the respective request.

23. The method of claim 1, wherein a first request and a second request are associated with different clusters as a result of a difference between a type of content contained in a webpage associated with the respective request.

24. The method of claim 1, wherein the model associates the request with the first cluster based on data comprised by the request and without historical data relating to a user.

25. The method of claim 1, wherein a user associated with the request is unaffiliated with any request previously processed by the model.

26. The method of claim 1, wherein the content is an advertisement to be displayed in a webpage.
